(19) United States
(12) Patent Application Publication
(10) Pub. No.: US 2016/0377546 A1
(43) Pub. Date: Dec. 29, 2016

(54) MULTI-FOCI MULTIPHOTON IMAGING SYSTEMS AND METHODS

(71) Applicant: TissueVision, Inc., Cambridge, MA (US)

(72) Inventors: Timothy Ragan, Somerville, MA (US); Elijah Yew, Somerville, MA (US)

(21) Appl. No.: 15/192,345

(22) Filed: Jun. 24, 2016

Related U.S. Application Data
(63) Continuation-in-part of application No. PCT/US2014/072368, filed on Dec. 24, 2014.
(60) Provisional application No. 61/920,654, filed on Dec. 24, 2013.

(51) Int. Cl. G01N 21/64; G02B 21/36; G01J 1/44; G02B 21/00

(52) U.S. Cl. CPC G01N 21/6458; G02B 21/006; G02B 21/361; G02B 21/0096; G02B 21/0076; G02B 21/0048; G01J 1/44; G01N 21/6486; G01J 2001/442; G01J 2001/4453

(57) ABSTRACT

Multi-foci multiphoton imaging systems and methods are provided herein which advantageously implement an excitation system that avoids aberrations and a restricted field of view while utilizing a non-descanned detection system with interlaced scanning that reduces crosstalk and provides for improved imaging of tissue. The non-descanned detection system can employ a high-efficiency fiber coupled detection.

### CROSS-REFERENCE TO RELATED APPLICATIONS

This application is a continuation-in-part of International Patent Application No. PCT/US2014/072368, filed Dec. 24, 2014, which claims priority to U.S. provisional application No. 61/920,654, filed Dec. 24, 2013, entitled “MULTI-FOCI MULTIPHOTON IMAGING SYSTEMS AND METHODS,” both applications being incorporated herein by reference in their entirety.

### BACKGROUND

A fundamental and ongoing challenge faced by biologists is to understand the function of complex biological systems. In addressing this challenge, the importance of knowing the global structure of the system has repeatedly proven crucial. Examples range from DNA to whole organisms: The discovery of DNA's double helix immediately suggested its copying mechanism, and the 3D arrangement of the 2D linear sequence of amino acids in a polypeptide chain was vital to reveal the basis of enzymatic specificity. In the case of an organ, the fundamental structural and genetic unit is the cell, and thus to faithfully to describe its architecture it's necessary to resolve the 3D position, morphometry, and biochemical state of individual cells throughout the organ. Unfortunately, no imaging tools exist which can quickly generate 3D subcellular images of whole organs. This represents a serious impediment to biomedical progress, particularly given the explosion of fluorescent based transgenic models, labeling protocols, and the overall rapid advancement in genomic and proteomic tools which demand subsequent phenotypic classification.

Two-photon (or multiphoton) excitation imaging, for example, two-photon microscopy (TPM), utilizes a fluorescence imaging technique that advantageously enables imaging of living tissue (in vivo) at a relatively high imaging depth. Typically, two-photon excitation imaging utilizes red-shifted excitation light to induce fluorescence in a sample (notably, using infrared light minimizes scattering in the tissue). More than one photon of excitation light are absorbed to reach an exited state. Due to the nonlinear nature of the excitation process, two-photon excitation imaging advantageously provides inherent 3D sectioning, an excellent imaging depth of several hundred microns, minimal photobleaching of out of focus regions, and superior background rejection arising from the wide separation of excitation and emission wavelengths. Thus, two-photon excitation imaging may be a superior alternative to confocal microscopy due to its deeper tissue penetration, efficient light detection, and reduced phototoxicity. Two-photon excitation imaging also offers significant advantages for ex vivo imaging. Unlike light sheet approaches it works well with opaque or partially cleared sample and there is little photobleaching of out of focus regions. Further, large field of views with small depths of focus can be used which are only limited by the optics of the objective. In contrast, the confocal parameter of the light sheet limits the field of view to often less than 500 microns and even within this region the z illumination profile can be 20 microns or more.

Previously, multiphoton imaging has employed a “descanned” methodology where light from the sample arrives at the detector after transmission through the scanning system. While the descanned approach has shown substantial improvement over a non-descanned approach, there still exist significant limitations. First, the field of view is restricted due to point spread function (PSF) aberrations in non-paraxial foci. Next, there is a significant (for example, 70% loss or greater) of the emission signal from de-scanning through the excitation optics. Also, high laser powers and thus high photon fluxes lead to large current at the common anode in a MA-PMT which results in either PMT saturation or damage. Thus, there exists a need for improved multi-foci multiphoton imaging systems and methods that address these and other limitations.

### SUMMARY

Systems and methods of the present disclosure implement high speed imaging in conjunction with sequential sectioning utilizing multi-foci multiphoton excitation that can advantageously image, for example, biological samples such as entire organs with micron resolution in less than a day. The systems and methods advantageously overcome several long standing technical problems with multi-focal, multi-photon microscopy (MMM) systems for deep tissue imaging, and are suited for ex vivo whole organ imaging. The ability to fluorescently image a whole organ in three dimensions (3D) at 1 micron XY sampling and 2 micron Z sampling in less than a day as enabled by the systems and methods described herein is poised to have a transformative effect on 3D histology and provide a crucial tool for researchers for a vast array of applications in neuroscience and other fields. The systems and methods of the present disclosure offer the highest imaging speed and sensitivity available for fluorescent subcellular whole organ imaging. Moreover the systems and methods of the present disclosure address several major problems with existing multi-foci multiphoton imaging technologies including, inter alia, problems of a limited field of view due to aberrations induced by the intermediate optics and problems with loss of emission photons in the descanned path.

More particularly, the systems and methods of the present disclosure may advantageously implement excitation methods that avoid aberrations and a restricted field of view as well as employing non-descanned detection that employs high efficiency fiber coupled detection with an original interlaced scanning strategy that minimizes foci crosstalk. Thus, the systems and methods of the present disclosure can result in an 8-12 times increase in imaging speed over previous configurations. Moreover, the use of non-descanned detection results in an improved collection efficiency relative to previous configurations using descanned detection. Other advantages of the systems and methods of the present disclosure include a large field of view with minimal point spread function (PSF) aberration and high image signal-to-noise ratio (SNR), minimal crosstalk between neighboring foci even in the presence of scattering environments, support for multiple channels, for example, multiple spectral channels (in some examples, there can be four (4) or more spectral channels, and in other examples, there can be up to sixteen (16) or more spectral channels), high pixel residence times, minimal photobleaching of out-of-focus regions, easy accommodation of larger organs, and suitability for both opaque and optically cleared samples. The detector system can be matched to an illumination system in which a beam shaping device is used to control the size, shape and incidence angle of individual beamlets that illuminate the sample at spaced focal locations.

Preferred embodiments employ automated control and data processing systems that are programmed to perform the sectioning and imaging operations described herein. Further preferred embodiments utilize imaging modalities such as coherent anti-stokes Raman scattering (CARS), stimulated Raman scattering (SRS), second harmonic imaging (SHG) optical computed tomography (OCT) and confocal reflectance microscopy. Consequently, multimodal imaging operations can be performed in conjunction with the systems and methods described herein.

### BRIEF DESCRIPTION OF THE DRAWINGS

FIG. 1 depicts an example multiphoton imaging system using a sequential sectioning process, according to the present disclosure.

FIG. 2 depicts example imaging systems wherein (i) a single foci is generated within an imaging plane and (ii) multiple foci are generated within an imaging plane, according the present disclosure.

FIG. 3 depicts an example multi-foci multiphoton imaging system including both non-descanning and descanning collection paths, according to the present disclosure.

FIG. 4A depicts the layout of an example multi-foci multiphoton imaging system, according to the present disclosure.

FIG. 4B depicts the layout of an example serial two-photon tomography microscope, according to the present disclosure.

FIG. 4C depicts an example excitation scheme for multi-foci multiphoton imaging wherein a foci generating element is downstream of a scanning element, according to the present disclosure.

FIG. 5 depicts a ZEMAX simulation of aberrations for each of (i) the configuration in FIG. 1 and (ii) the configuration in FIG. 3, according to the present disclosure.

FIG. 6 depicts an example coupling of a fluorescent signal into a liquid light guide (LLG), according to the present disclosure.

FIG. 7A depicts an example interlaced scanning strategy where contiguous regions are scanned sequentially, according to the present disclosure.

FIG. 7B depicts light paths through an objective for foci at different positions on a sample according to the present disclosure.

FIG. 7C depicts an exemplary system including individual output fibers associated with each foci according to some embodiments of the present disclosure.

FIG. 8 depicts an example PMT assembly for four channel detection, according to the present disclosure.

FIGS. 9A-9B depict example layouts for detection of the disposition of a scanning mirror, according to the present disclosure.

FIG. 10A depicts an example of chromatic aberration that can occur from using a diffractive optical element, according to the present disclosure.

FIG. 10B depicts an example of optical elements with refractive indices n1, n2, n3 and Abbe numbers v1, v2, v3 that can be used to compensate for chromatic aberration, according to the present disclosure.

FIGS. 11A-11E depict example layouts of various types of detection configurations, according to the present disclosure.

FIGS. 12A-12C depict example layouts of additional types of detection configurations, according to the present disclosure.

FIG. 13 schematically depicts an exemplary system to provide beamlets for illumination according to some embodiments of the present disclosure.

FIG. 14A schematically depicts an exemplary system including a diffractive optical element to provide beamlets for illumination according to some embodiments of the present disclosure.

FIG. 14B schematically depicts an exemplary system to provide beamlets for illumination including one or more 4-f relay systems in accordance with some embodiments of the present disclosure.

FIG. 15A schematically depicts a portion of an exemplary system including beam splitters and mirrors to provide beamlets for illumination according to some embodiments of the present disclosure.

FIG. 15B schematically depicts a portion of an exemplary system to provide beamlets for illumination that allows adjustment of intensity in each beamlet according to some embodiments of the present disclosure.

FIG. 16 depicts a process flow sequence for imaging a biological sample, 3D images of biological samples or whole organs in accordance with preferred embodiments of the invention.

### DETAILED DESCRIPTION

Multi-foci multiphoton imaging systems and methods are provided herein which advantageously implement excitation systems that avoid aberrations and the more restricted field of view of existing systems. Example systems according to the present disclosure can include a non-descanned detection system that employs high efficiency fiber coupled detection with interlaced scanning that reduces foci crosstalk.

Additional details regarding multiphoton imaging and systems for automated control and data processing of tissue such as whole organs are described in U.S. application Ser. No. 11/442,702 and also in PCT Publication No. 2006/127967, both filed May 25, 2006, and directed towards “Multifocal Imaging Systems And Methods.” The present disclosure also builds upon and relates imaging, process control and data processing operations described in U.S. Publication No. 2013/0142413, filed Dec. 26, 2012, and directed towards “Systems And Methods For Volumetric Tissue Scanning Microscopy.” The entire contents of the foregoing PCT and US patent publications are hereby incorporated by reference. These systems utilize automated sectioning of tissue in combination with spectroscopic imaging and detection to generate tissue atlases or for later processing and image analysis.

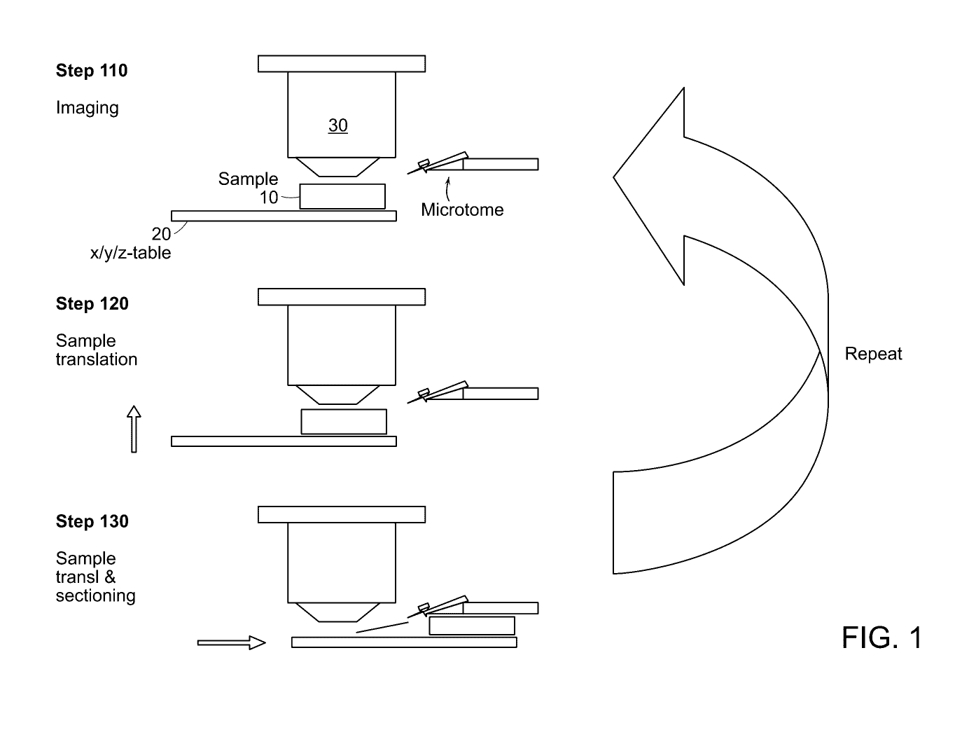

While two-photon excitation imaging can image several hundreds of microns in depth in scattering tissues, it cannot image through multiple centimeters to image entire opaque organs. For imaging a sequence of sections, a fixed agar-embedded mouse organ, is placed on an integrated x-y stage under the objective of a TPM system and imaging parameters are entered for automatic image acquisition. Once these are set, the instrument can advantageously work fully automatically. As depicted in FIG. 1, first, at step 110 the x-y-z stage 20 move the sample 10 under the objective 30 so that an optical section (or an optical z stack) is imaged as a mosaic of fields of view. Next the sample is translated (step 120) and a built-in vibrating blade microtome mechanically cuts off a sample section from the top of the sample 10 (step 130). The steps of overlapping optical (step 110) and mechanical (step 130) sectioning are then repeated serially while stepping through the sample (step 120) until a full dataset is collected for the sample. Thus, the organ imaging sequence steps down through the organ with enough overlap between adjacent slices for images from different layers to be co-registered. Notably, imaging the tissue before it is cut provides far greater fidelity and sidesteps complications of standard histological sectioning which images the tissue after it has been cut (and thus distorted).

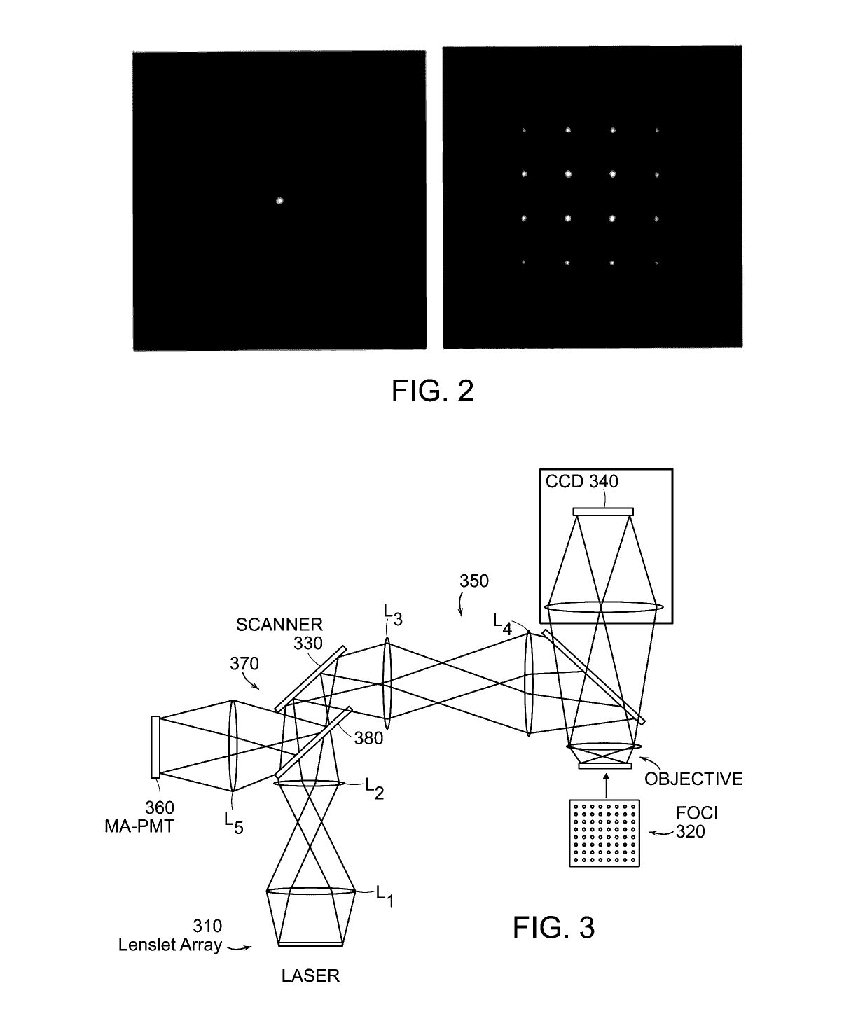

While sequential sectioning using TPM has proven robust, imaging speed can become a bottleneck for high-throughput applications due to the speed limitations of single point scanning. Various methods have been introduced to increase the acquisition speed. One solution is to scan a single foci quickly with a polygonal or resonant scanner. However this leads to short pixel dwell times with low numbers of photons/pixel and thus poor contrast. In the MMM approach a lenslet array or a diffractive optical element is used to generate multiple foci within the imaging plane. See, e.g., FIG. 2 depicting on the left single foci in a fluorescein solution and on the right a 4×4 array of foci. Advantageously, multiple foci can be scanned in parallel to increase the frame rate.

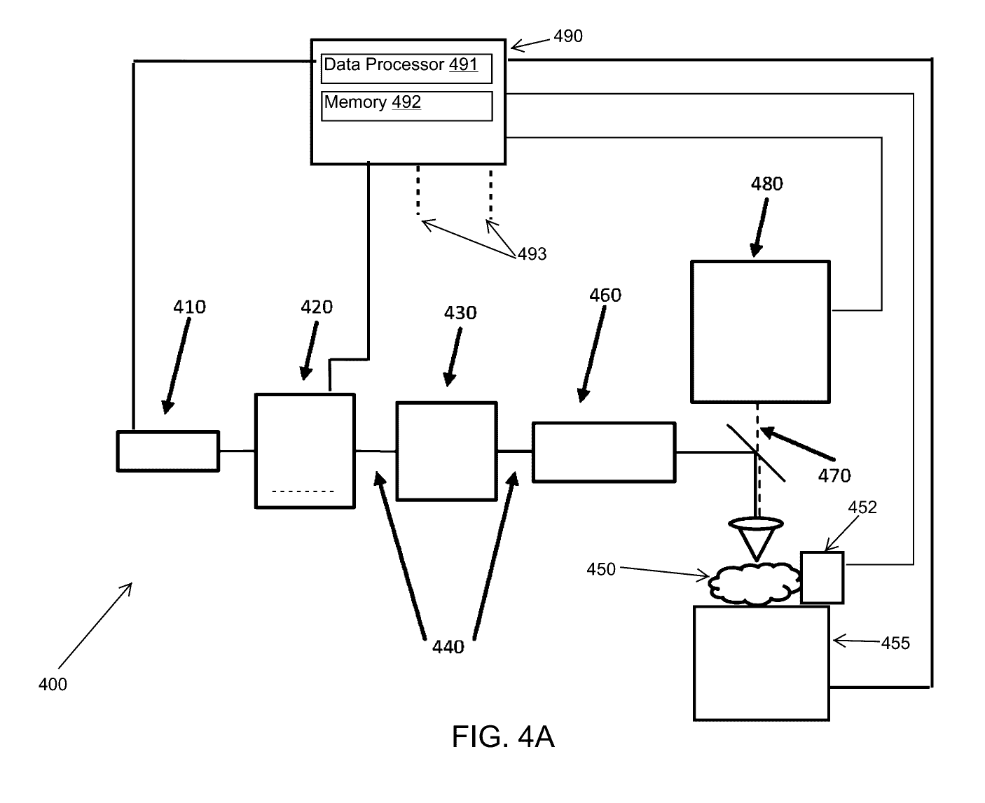

With reference to FIG. 3, a lenslet array 310 or diffractive optical element is used to generate multiple foci 320 within the imaging plane. In examples, these foci can be scanned (using scanning mirrors 330) in parallel and a CCD camera 340 or other detection means can be used to detect the fluorescent photons along a non-descanned path 350. However this method may present some limitations: when imaging turbid samples, the emission photons may scatter into neighboring CCD pixels and the imaging depth can become very restricted, often less than 50 microns.

With reference still to FIG. 3, one way of addressing the scattering issue, is to use a descanned detection configuration, for example, that employs a multi-anode photomultiplier tube (MA-PMT) detector 360, or other detector along a descanned path 370. The scanned foci 320 were directed back towards the MA-PMT detector 360 which may exhibit the same configuration as the foci (for example, an array of 4×4 foci directed towards a 4×4 multi-anode MA-PMT array). FIG. 3 illustrates the descanned geometry where the emission photons travel back along the same path 370 as the incoming laser light, and after passing the scanning mirrors 330, are split with a dichroic element 380 and directed towards the MA-PMT detector 360. With the large area of the each anode, the scattered emission photons are collected in the designated channels, and the scattering effect is suppressed resulting in high signal to noise ratio (SNR).

As described herein, a possible limitation of the descanned MMM system shown in FIG. 3 is that the imaging field of view is limited due to aberrations induced by the low f-number intermediate optics L₁, L₂, L₃, and L₄. In particular, after the excitation beam passes through the lenslet array 310, its diameter must be decreased in order to accommodate the small scan mirrors, and then re-expanded to overfill the back aperture of the objective lens. Thus, optics L₂ and L₃ of FIG. 3, in particular, have poor f-numbers though and generate large aberrations especially for edge foci. This can limit the final effective field of view. While larger size scanning mirrors are available to mitigate aberrations from the reduction and expansion, these mirrors typically lack sufficient bandwidth for fast scanning. In addition, larger separation between the scanning mirrors can generate non uniformity of excitation laser power over the whole scanning area.

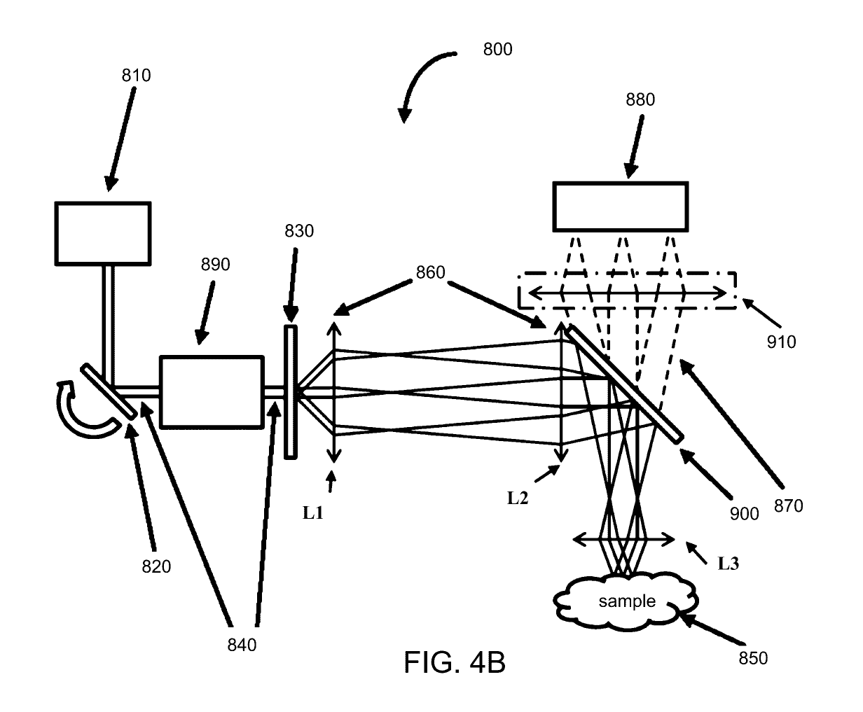

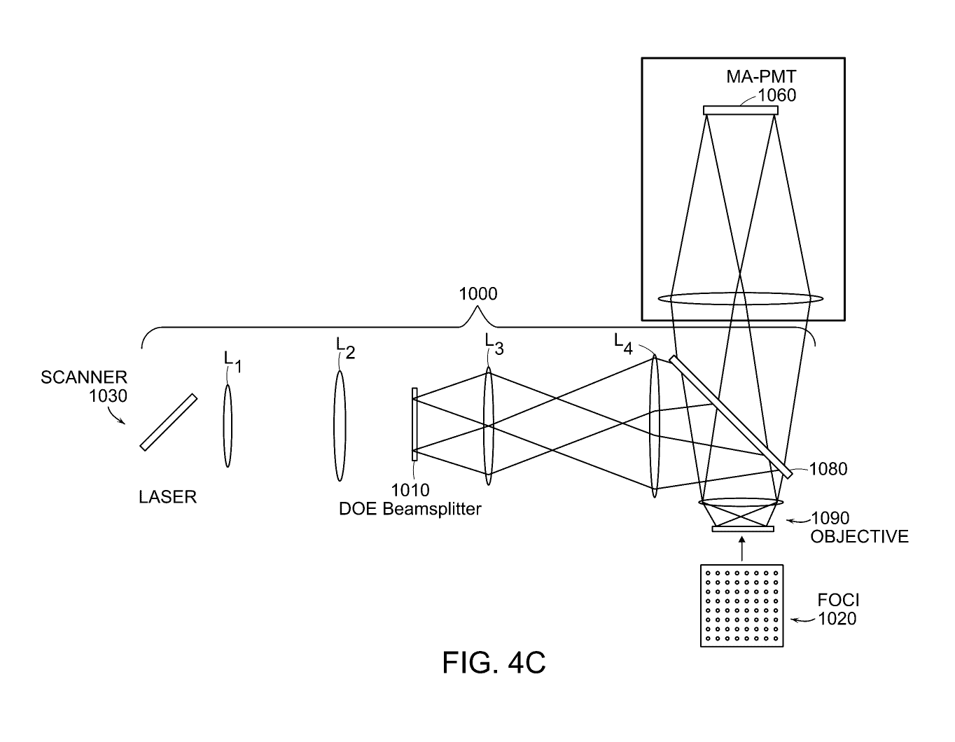

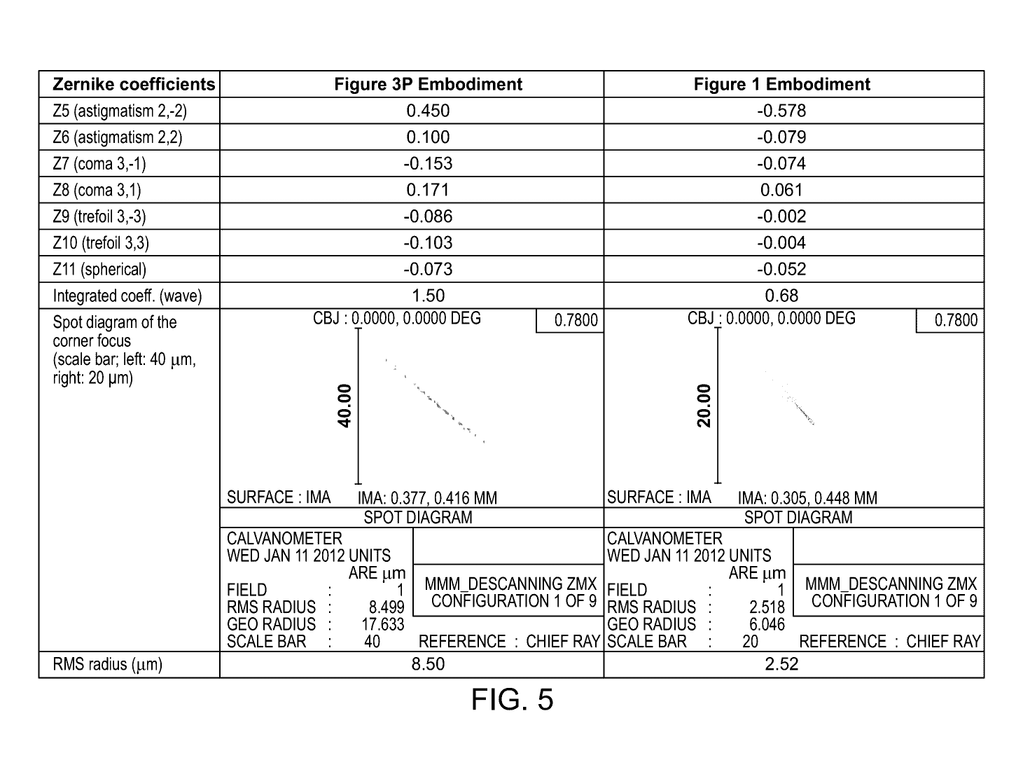

FIG. 4A shows a block diagram of a high speed serial tomographic microscope that can be used for nonlinear optical microscopy such as multi-photon, CARS and SHG microscopy. A preferred embodiment is directed to a multi-foci multiphoton imaging system 400, according to the present disclosure. As described herein, an example of a multi-foci multiphoton imaging system 400 can be configured as a high-speed serial two-photon tomographic microscope. The multi-foci multiphoton imaging system 400 includes a source 410 of electromagnetic radiation, a scanning element 420, and a foci generating element 430.

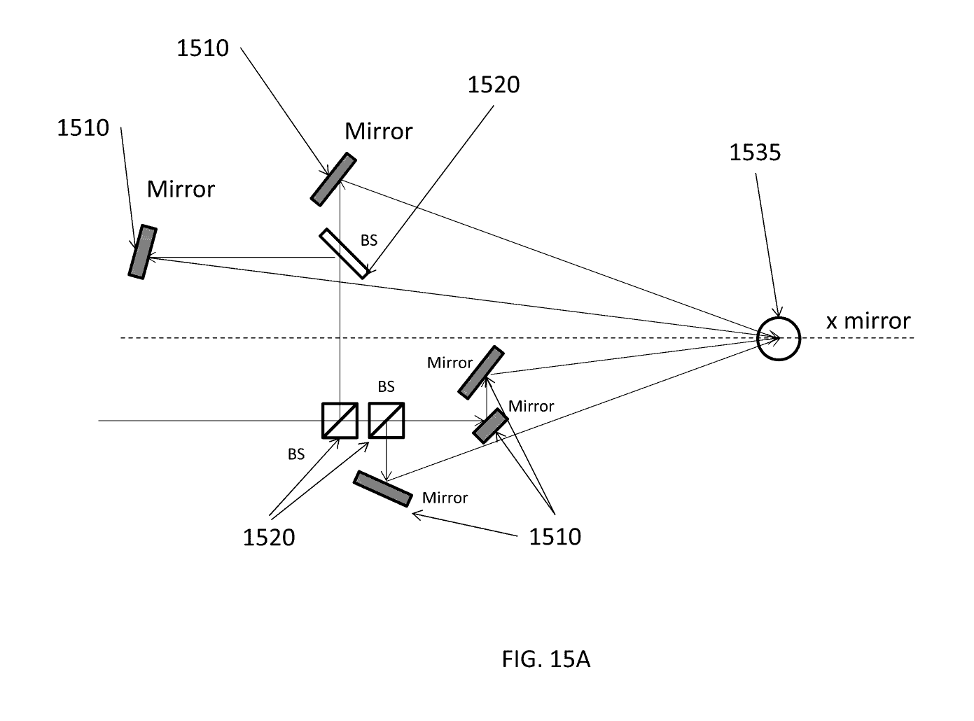

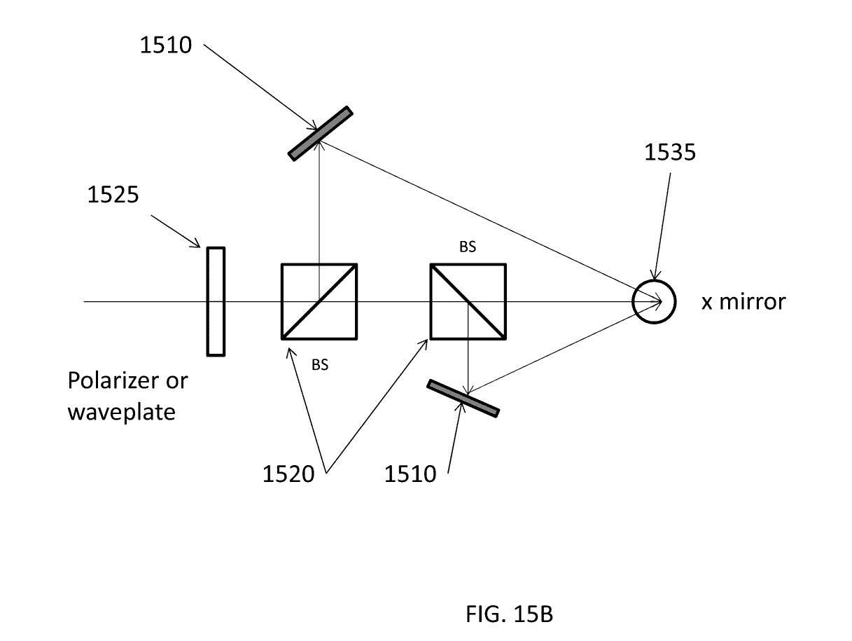

The light excitation path 440 from the source 410 to a sample 450 includes the foci generating element 430 to generate a plurality of foci from an excitation beam and the scanning element to scan the foci across the sample 450. The system 400 can include an translation stage 455 and/or tissue sectioning apparatus 452. Each of the translation stage 455 and tissue sectioning apparatus 452 can be controlled by the control system 490. In the example of a multi-foci multiphoton imaging system 400, the foci generating element 430 receives light from the scanning element 420 along the light excitation path 440. One or more optical elements 460 can be disposed along the light excitation path 440. A control system 490 including a data processor 491 and a memory 492 can control the operation of the light source 410, scanning element 420, and/or object control unit 455 and can receive data from the detector 480. As also depicted in FIG. 4A, the light collection path 470 includes a detector 480 that detects fluorescence emissions from the sample 450. In the example of FIG. 4A, the layout of the multi-foci multiphoton imaging system 400 is split into operational units to reflect the modular nature of the microscope. According to the principles described herein, customized changes can be made to the individual operational units of the system with minimal adjustment to the remaining optics. The imaging system 400 can include automated use of the control system 490 to operate the light source, scanner, detector, translation stage and other moveable or dynamic operational units to more efficiently conduct imaging of the tissue. The control system 490 can also include control outputs 493 to control additional elements of the system 400. For example, the control system 490 can use the control outputs 493 to adjust translation and tilt of mirrors as described below with reference to FIGS. 15A and 15B. A data processor 491 is connected to the detector 480 to process image data as described generally herein. The control system 490 and data processor 491 are operative in response to software stored in memory 492 to automatically select imaging parameters and to perform image processing in accordance with selected preset processing operations described herein. Further details concerning use and operation of automated vibrating sectioning tools can be found in U.S. Pat. No. 8,839,700, originally filed as U.S. application Ser. No. 13/166,472 on Jun. 22, 2011, the entire contents of which is incorporated herein by reference. Preferred embodiments employ a tissue sectioning apparatus 452 such as a vibrating blade mounted on a controlled moveable stage in conjunction with a controlled sample translation stage 455 to perform a sequence of optical sectioning and physical sectioning of layers to image and further process the sample and layers thereof.

FIG. 4B shows a block diagram of an example multi-foci multiphoton imaging system 800 configured as a serial two-photon tomography microscope, according to the present disclosure. The multi-foci multiphoton imaging system 800 includes a source 810 of electromagnetic radiation, a scanning element 820, and a foci generating element 830. The light excitation path 840 from the source 810 to a sample 850 includes the foci generating element 830 to generate a plurality of foci from an excitation beam and the scanning element to scan the foci across the sample 850. In multi-foci multiphoton imaging system 800, the foci generating element 830 receives light from the scanning element 820 along the light excitation path 840. One or more optical elements 860 can be disposed along the light excitation path 840. As also depicted in FIG. 4B, the light collection path 870 includes one or more detectors 880 that detect fluorescence emissions from the sample 850. In the example of FIG. 4B, the layout of the multi-foci multiphoton imaging system 800 is split into operational units to reflect the modular nature of the microscope.

As shown in FIG. 4B, excitation light from the source 810 is incident on a scanning element 820 that is positioned appropriately such that it will deflect the beam and cause it to scan across the sample 850 in the lateral (x-y) plane. The non-limiting example of FIG. 4B shows a single scanning element 820 that can be implemented to scan the light along a single dimension. In another example, at least two such scanning element 820 can be used for multi-dimensional scanning. The sample 850 may also be scanned in conjunction with the scan of the mirror of the example scanning element 820.

As also shown in FIG. 4B, the example multi-foci multiphoton imaging system 800 includes an optical relay 890. The excitation light can continue from the scanning element 820 through optical relay 890 that is configured to expand or shrink the beam of excitation light. The excitation light passes through a foci generating element 830 (configured as a beam-splitting device) that splits the incident light beam into multiple beams, each fanning out at an angle that may be determined by the user beforehand or in real-time. This beam-splitting device can be configured to be passive or active, to facilitate control of one or more of the fan-out angles, the number of foci, and whether each foci is turned ON (i.e., to cause fluorescence emission at the sample) or OFF. In various examples, the foci generating element 830 can be many different types of beam-splitting elements, such as but not limited to a diffractive optical element, a holographic element, or a spatial light modulator. The beams of excitation light continue through the one or more optical elements 860 formed as an optical train (L1 and L2) that images the beam-splitting device on to the rear aperture of the objective L3. The beams of excitation light can pass through a dichroic 900 that separates the excitation light from the signal light. In this case, the dichroic reflects the excitation light towards the objective (L3) and the various beams are focused on to the sample. The signal can be generated from the foci as they are scanned along the sample 850 using the scanning element 820. The signal propagates back through objective L3 and passes through the dichroic 900 and detections optics 910 before being projected on to the one or more detectors 880.

The advantage of having multiple spots is that it speeds up the throughput of the system. This parallelization is of great benefit in the event of slow processes where the dwell time per pixel is long. Examples of such include phosphorescence or fluorescence lifetime imaging where the relaxation is on the order of milliseconds and the point scan of the large area will take too long. This is particularly important in situations where the expression of the desired proteins, and hence the fluorescence signal, is low.

With reference to FIG. 4C, an example excitation system 1000 is depicted that, similarly to the example systems of FIGS. 4A and 4B, advantageously avoids the problems of poor f-numbers but still allows for small, fast mirrors as well as a non-descanned configuration. The excitation system 1000 advantageously places the scanning elements 1030 before the foci generating element 1010, depicted as a diffractive optical element (DOE) but may alternatively include a beam splitter or a lenslet array. The dichroic element 1080 is located between optic L4 and the objective lens 1090 so that the emission photons can reach the detector 1060 (depicted as a MA-PMT) via a relatively short path length.

Since the scanning elements 1030 are before the foci generating element 1010 in the excitation path, the laser beam diameter (˜2.5 mm) can remain minimized, thus enabling the use of fast, small (less then 4 mm and preferably about 3 mm or less) scanning mirrors. Only after passing through the scanning mirrors, is the laser beam expanded to fill the foci generating element 1010 (maximum DOE diameter of 23 mm in the depicted example) using the lens pair L₁ and L₂ (forming a 4-f lens system in the depicted example). Note that, as depicted, the foci generating element 1010 is in a conjugate plane of the scanning elements 1030 and thus only the incident angle varies. After the foci generation element 1080 the laser beam is again expanded (using the second lens pair L₃ and L₄) to slightly overfill the back aperture of the objective lens 1090. With this gradual beam expansion, all the f-numbers stay in an acceptable range for the objective lens 1090 in question.

To illustrate, Table 1 compares the f-numbers of the optics in FIG. 3 versus the optics in FIG. 4C that can be used to achieve a full field of view (1 mm diameter at a sample plane) of a 20× objective lens (W Plan-Apochromat, 1.0 NA, Zeiss, Thornwood, N.Y.), which provides about 800 μm×800 μm scanning area. Generally an f-number of at least 10 is recommended for a singlet lens and greater than 5 for a doublet lens. For the configuration in FIG. 3, the optics require two very low f-numbers (lens elements L₂ and L₃) which results in greater aberrations. In contrast, the lowest f-numbers for the configuration in FIG. 3 is 5.9 where L₁ is a theta lens, which can easily afford an f-number of 5.9, and L₃ is a doublet.

TABLE 1

f - numbers

| Lens Element | L1 | L2 | L3 | L4 |
|---|---|---|---|---|
| FIG. 3P | 7.0 | 2.3 | 2.0 | 5.7 |
| FIG. 1 | 5.9 | 7.9 | 5.9 | 7.6 |

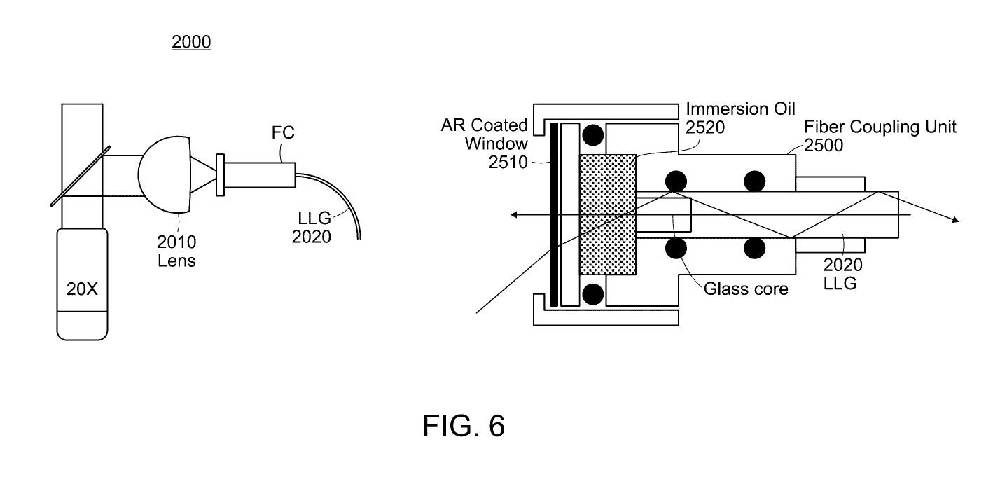

In FIG. 5 an initial ZEMAX simulation is presented showing that the configuration in FIG. 4C offers significantly lower aberrations than the configuration in FIG. 3. Advantageously, the geometry of FIG. 4C avoids low f-numbers and generates less aberration. The aberration coefficients were calculated and spot diagrams were simulated. With the improved aberration coefficients, the root mean square (RMS) radius becomes smaller by over a factor of 3, resulting in much more effective two-photon excitation. Note that this simulation was done for the worst case of a corner foci of an 8×8 array. Further improvements can be realized with aspheric optical components.

Turning to the emission path, as noted herein, one difficulty with non-descanned detection is that the fluorescence signal is no longer stationary at the image plane. While the translation of the signal (resulting from the translation of the foci) on the image plan is easily accounted for when using CCD or CMOS imaging devices, a greater problem is presented for PMT and MA-PMT detection. Even though each anode of the MA-PMT has a relatively large area, as the foci are scanned in the object plane of the objective, it is possible for emission photons to scatter into neighboring MA-PMT pixels in the image plane, particularly near the edge of a PMT pixel. Further, MA-PMTs have dead regions surrounding each pixel which, if uncorrected, lead to blank areas in the image. This can be dealt with in principle by placing a lenslet array or array of non-imaging collectors to help keep the fluorescence focused on the center portion of the PMT pixel. However, it is still less than ideal since it does not prevent optical crosstalk from scattering photons and electronic crosstalk from the MA-PMT. More troublesome for ex vivo whole organ imaging, where high photon fluxes are to be expected, is that MA-PMT devices have the same current limit as a single PMT, but this current limit must now be spread amongst several foci. Thus, detector saturation becomes a real issue.

To solve all these issues example systems and methods implement detection which (i) can utilize interlaced regional scanning to remove optical crosstalk and (ii) utilize fiber optic coupling of the detected light on a per foci basis allowing for use of a single PMT per foci. Advantageously, the fiber optics overcome steric constraints. Moreover, the detection system results in a substantial reduction in optical crosstalk and elimination of detector electronic crosstalk and dead space. Collection efficiency is also increased (collection efficiency actually surpasses normal air coupled detection) and better spectral discrimination is achieved due to randomization of the light after passing thru the light guides. The use of fiber optics also allows for high modularity and convenient placement of detectors off the imaging unit itself. Finally, since this detection system enables using a single PMT per foci per spectral channel, MA-PMT current saturation is no longer a concern.

Fiber coupling of a fluorescence signal in a TPM system has traditionally been viewed as inefficient compared to air coupled detection. However, large core fiber-optic fluorescence detection with high numerical aperture (NA), low magnification objectives, shows substantial improvement in collection efficiency over traditional air coupled detection schemes. See, e.g., Mathieu Ducros et al., “Efficient Large Core Fiber-based Detection for Multi-channel Two-photon Fluorescence Microscopy and Spectral Unmixing,” Journal of Neuroscience Methods 198, no. 2 (Jun. 15, 2011): 172-180, doi:10.1016/j.jneumeth.2011.03.015. Specifically, by placing a fiber optic near an objective, and making use of AR coatings and immersion oil coupling to reduce index mismatches, high collection efficiencies are achievable that have a 7× improvement over the standard air coupled path. Moreover, due to mode scrambling within the fiber, spatial non-homogeneity detection sensitivity cancels itself out leading to improved spectral discrimination. Fibers utilizing an AR coating and immersion oil coupling are also referred to herein as liquid light guides (LLGs).

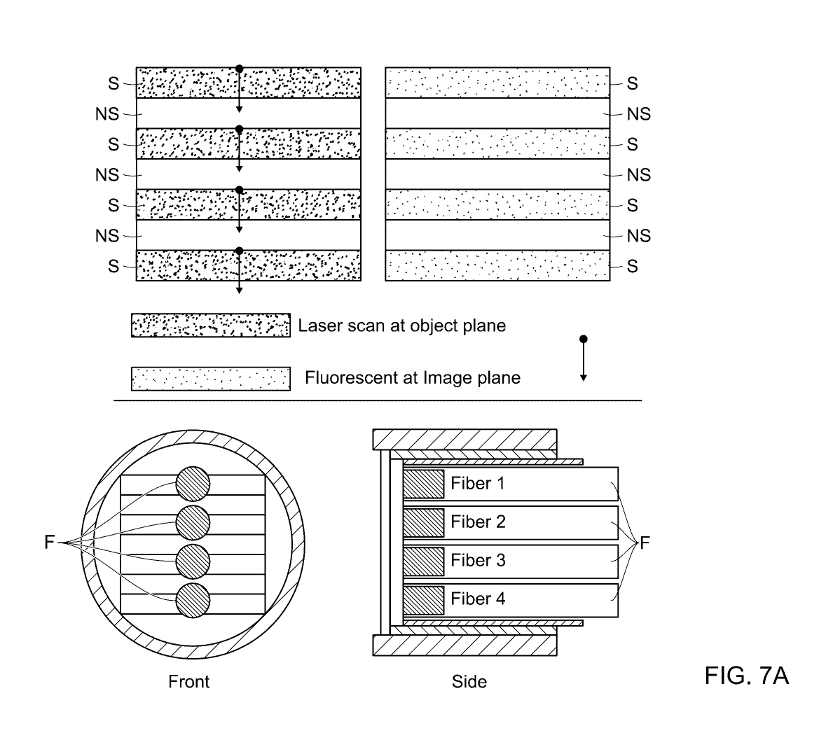

FIG. 6 depicts an example coupling of a fluorescent signal into a liquid light guide (LLG) (See Ducros et al., referenced above). In particular, on the left an example emission path optical layout 2000 is depicted wherein a lens 2010 focuses emitted light onto the liquid light guide (2020). A detailed depiction of a liquid light guide interface 2500 is depicted on the right. In particular, the interface includes an AR coated window 2510 interfaced to oil 2520 which index matches to the input of the LLG 2020. Losses were shown to be less than 0.4%. This design, however is not well suited for a multi-foci system due to cross-talk in the collection path.

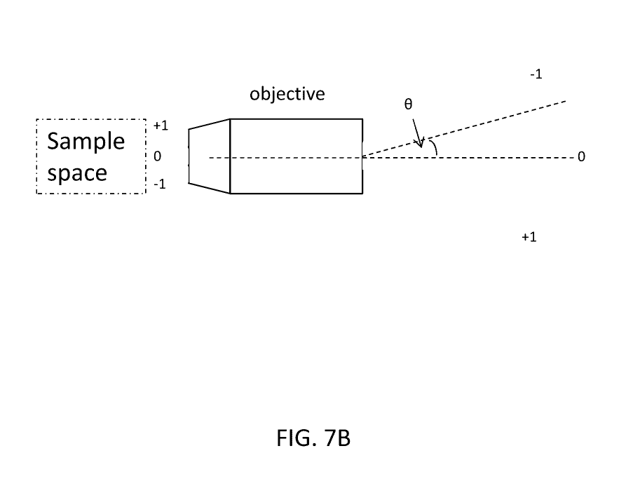

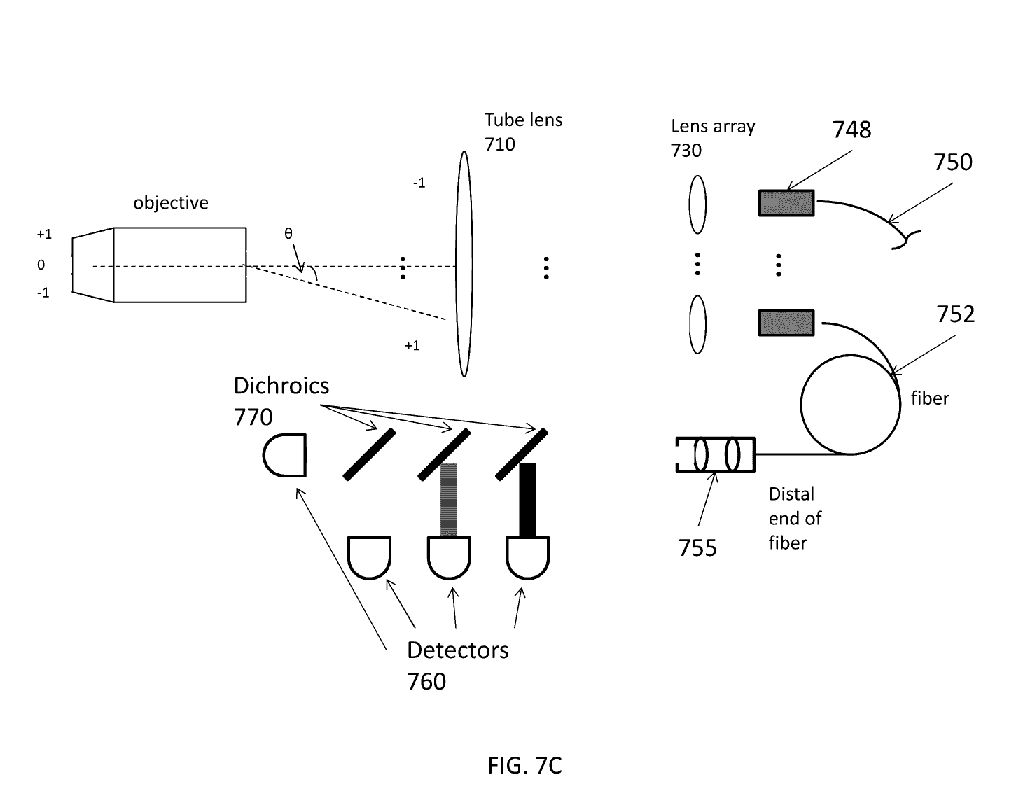

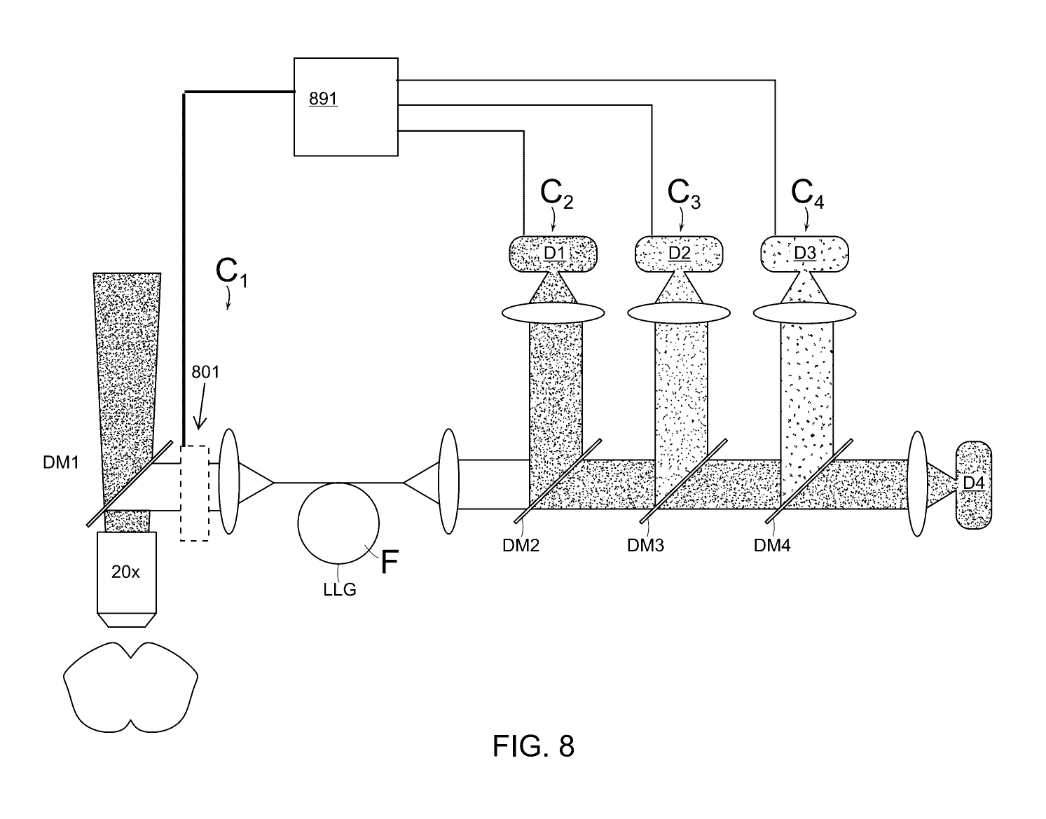

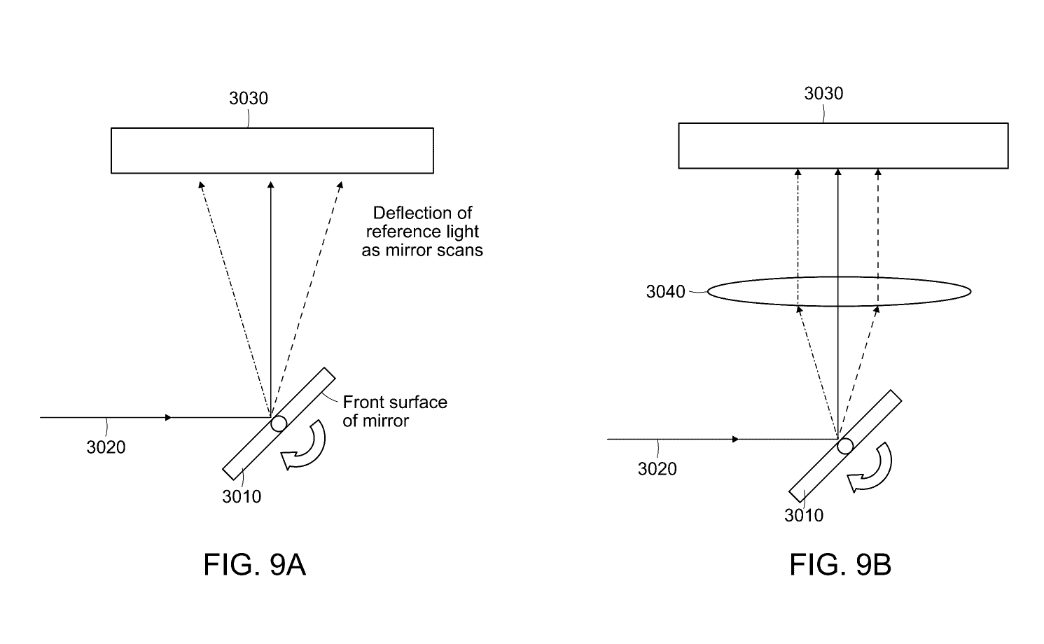

Systems and methods of the present disclosure may advantageously implement an interlaced scanning method that enables coupling a 1×N arrangement of foci into 1×N array of fibers, for example, LLGs. FIG. 7A demonstrates an example of an interlaced scanning strategy where contiguous regions are scanned sequentially either through the use of an additional movable mirror 801 (shown in FIG. 8) in the emission path to reposition the emission photons onto the LLGs foci, or by physically translating the sample under the objective. Since each individual interlaced scan takes half the time, there is little performance degradation in interlacing the scan. This strategy reduces photon scattering cross talk, and provides steric space to place the LLGs. As depicted, regions S represent the regions currently scanned in the object plane of the objective while regions NS represent regions which were previously or are subsequently scanned. Note that the fibers F are purposely larger than the chosen scan region S in order to better capture scattered photons from individual foci. However, depending on the scattering conditions, smaller diameters can also be used. Note that an N×N array of fibers can comprise a light collection embodiments that can also be employed with appropriate scan parameters for both light illumination and collection scanning. The number of fibers can correspond to the number of foci illuminated at each scanned location.

As can be seen from FIG. 7A, the fibers F cover the scan region in the horizontal, slow axis Y-scan direction, but not the fast X-scan direction. An approach is to demagnify/focus the image in the X direction. This can be done by using a cylindrical lens in the emission path. For instance, when coupling an Olympus 20× 1.0 NA lens, which has a front focal length of 9 mm, with a 200 mm tube lens, the system generates an image height of 17.6 mm Each individual scan has a 2.5 mm height, for example. A fiber with a 4 mm core and center can be employed on each scan region. To demagnify the X-scan, a doublet of two cylindrical lenses having an 80 mm focal length (effective focal length of 40 mm) can be used to obtain a demagnification of 5, giving the x-axis a linear extent of 17.6 mm/5=3.5 mm, which can fit within the 4 mm light guide input. Note that while in the depicted examples, a single lens (cylindrical doublet) is used to focus all foci at once onto a single fiber optic assembly, it is also possible to use a rectangular cylindrical lens or mirrors angled such that the fluorescent light from each foci is independently focused onto each fiber, for example, to allow wide flexibility in magnification and placement of the fibers and downstream optics. The proximal ends of the fibers can be fixed by a holder with the fibers aligned in parallel, or optionally at different angles.

As depicted in FIG. 7B, a lateral shift in the x (or y) direction in the sample by the foci can be brought about by an angular tilt of the x (or y) scanning mirror resulting in the beam entering the objective at some angle θₓ (or θ_{y}). In this manner, the focal spot or spots may be positioned anywhere in the sample by appropriately deflecting the scanning mirrors to the required angles. Due to reciprocity, signal generated within the sample, in the absence of scattering, exits the objective at the same angle with respect to the optical axis as the excitation beam. In this manner, the signal from each foci can exit the objective over a range of angles that correspond to the limits of the scan range on the sample.

FIG. 7C depicts an exemplary system that guides light from the various foci to individual output fibers or light guides. A tube lens 710 of suitable size and focal length can be placed so as to form an image of the foci at an image plane. An array of lenses 730 can be positioned at a suitable location after the image plane and each lens in the array can image the back aperture of the objective to individual fibers 750, 752. In some embodiments, the ratio of the focal lengths of the tube lens 710 and the lens array 730 can be such that the image of the back aperture of the objective fits completely within the entrance aperture of the fiber 750. The proximal end of each of the plurality of light guides 750, 752 can be fitted with a holder 748 for mounting and alignment. The guide holders 748 can optionally include a transmissive cover, a lens, or collimator with an appropriate anti-reflective coating. In this manner, each foci can be captured by the appropriate fiber 750 with minimal cross-talk. When scattering is present, the entrance aperture of the fiber 750 may be made larger relative to the image of the back aperture of the objective. In some embodiments, increasing the size of the entrance aperture of the fiber 750 relative to the image of the back aperture of the objective can be accomplished by selecting the appropriate magnification based on the focal lengths of the lenses or by selecting a fiber with a larger entrance aperture. In some embodiments, the distal end of each output fiber 750, 752 can be coupled to an individual detection path including detectors 760, filters, dichroics 770, or other associated optics. In some embodiments, output from each of the distal ends of the output fibers 750, 752 can be multiplexed and can use common detection elements including detectors 760, filters, dichroics 770, or other associated optics along a common detection path.

In an exemplary embodiment, a Nikon 16× NA0.8 (focal length=12.5 mm) water dipping objective can be used having a back aperture of 20 mm. For the case of a 1-D array of three foci to be imaged to the light-collecting fibers, each focus can be separated by 0.5 mm for a total separation of 1 mm, the three foci exit the objective at angles of −2.3°, 0°, and 2.3°, respectively. In some embodiments, the central axis of the light-collecting fibers are each spaced 5 mm apart, and the appropriate focal length of the tube lens is given by f_{TL}=5/tan(2.3°). In such embodiments, a tube lens of focal length 124.5 mm is therefore sufficient. For the image of the back aperture to fit within the 5-mm entrance aperture diameter of each of the light-collecting fibers, the magnification has to be smaller than 0.25×. The lens array can therefore have a focal length shorter than 31.13 mm.

From FIG. 7C, light can exit from the distal end of each fiber and can be collimated using one or more collimating lenses 755. The infinity space of the collection fiber output path is suitable for the placement of various optical elements such as dichroics 770, gratings, or beamsplitters for the purposes of analyzing or discriminating the signal based on the various properties of the signal such as lifetime, spectrum, or time delay. The detectors 760 can be PMTs or other detector elements as described herein.

FIG. 8 illustrates an example PMT assembly for four channel detection (C₁, C₂, C₃ and C₄) from a single fiber F. Due to the mode scrambling within the fiber F, the output of the fiber F is independent of the input incidence angle, and is spectrally split into 4 PMTs. For example, light was split at 620, 580, 540, and 500 nm to provide four channel detection at these wavelengths. A scanning device 801 can be controlled by control signals from controller 891 to coordinate collection of emitted light from the foci as they are scanned by the illumination system as described herein to perform interlaced scanning.

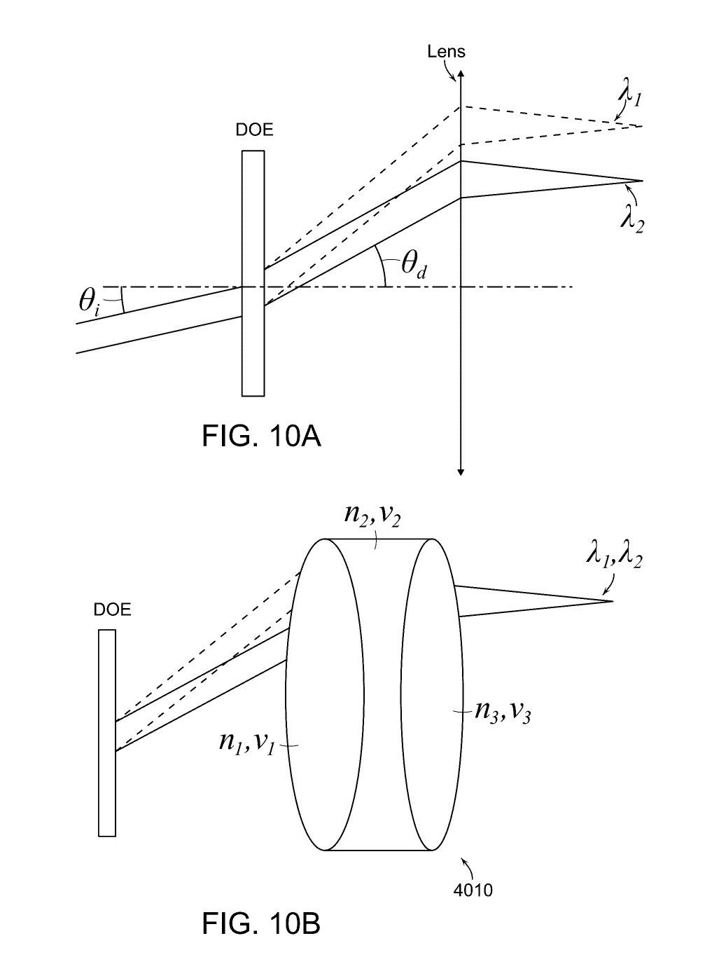

As shown in FIGS. 9A and 9B, any example scanning element according to the present disclosure, including any one or more of scanning elements 420, 820 or 1030, can include one or more scanning mirrors 3010 to facilitate the scanning of the foci across the sample. The disposition of the scanning mirrors (including position or orientation) should be known, as they are subject to mechanical errors that can affect the reconstruction of the image. In an example, the disposition of the one or more scanning mirrors 3010 (such as position and/or orientation) can be determined using a beam 3020 of a laser that is directed at the rear of the scanning mirror(s), where the front surface of the one or more scanning mirrors 3010 is in the excitation light path described hereinabove. The deflection of the beam 3020 can be detected using a sensor 3030. The detector of the sensor 3030 is large enough to accommodate the translation of the beam 3020 as it is deflected off the one or more scanning mirrors 3010. The detector also can be configured to have a sufficiently high resolution (such as, but not limited to, a CCD or a linear CCD) to determine the position of the beam. FIG. 9A illustrates the deflection of the beam 3020 that can occur as the one or more scanning mirrors 3010 perform the scan. In the example of FIG. 9B, a lens may be used to focus down the beam 3020 and improve the detection of the position of the one or more scanning mirrors 3010.

In any example implementation of a system herein, the foci generating element can be a diffractive optical element. A diffractive optical element works by diffracting light into the desired orders and may be used as a beam-splitting element. A diffractive optical element, however, can be sensitive to the wavelength of light that is incident upon it. In general, the diffracted angle follows the grating equation:

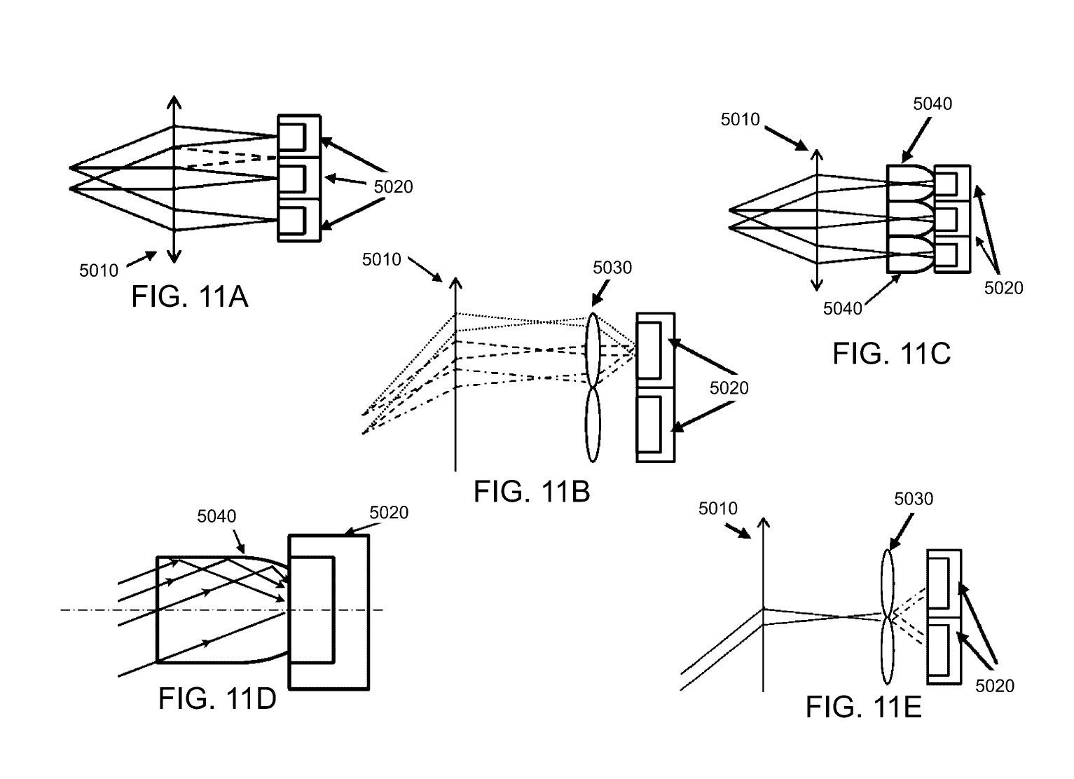

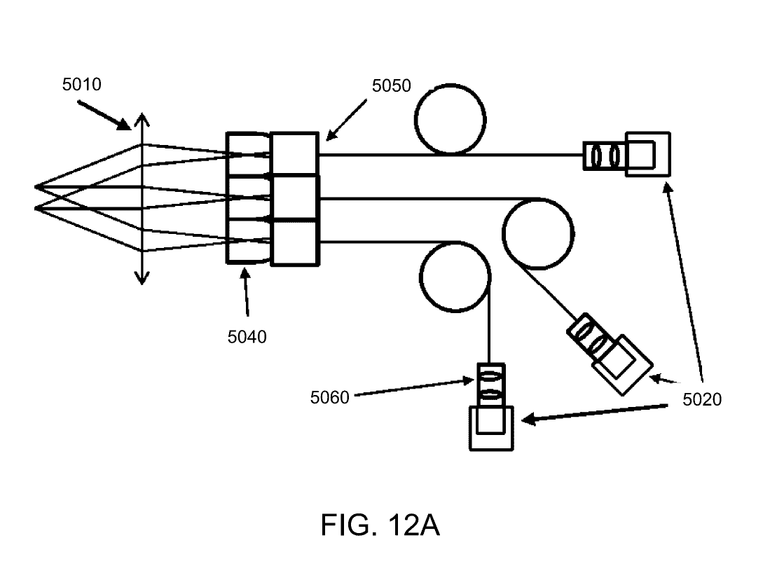

sin θ_{d}=mλG−sin θᵢ

where θᵢ,θ_{d} are the incident and diffracted angles, respectively, m is the diffraction order, λ is the wavelength of the incident light, and G is the grating constant that is a measure of the grating frequency. FIG. 10A illustrates the chromatic aberration that can occur as a result of using an example diffractive optical element (DOE) and without any chromatic correction optics. The wavelength dependence of the diffracted angle can lead to chromatic aberrations. Correction for this aberration can facilitate better performance of the system and provide better images, because (i) the image resolution may not be uniform throughout the image but can decrease towards the edges of the image due to aberrations; (ii) the efficiency of the two-photon excitation decreases as a result of dispersion at the focus; and (iii) to ensure that it is possible to perform co-localization analysis when using multiple wavelengths (such as but not limited to 800 nm and 1064 nm), or in situations where the overlap of the excitation beams are a factor (for example, in Coherent Anti-Stokes Raman Scattering (CARS), pump-probe spectroscopy, SRS and/or sum-frequency generation).

Example multi-foci multiphoton imaging systems are provided herein that are configured to compensate for chromatic aberration to maximize the resolution. In an example, one or more optical elements can be used along the excitation light path, where the one or more optical elements introduce chromatic dispersion equal and opposite to that produced by the diffractive optical element. In an example, the one or more optical elements can be configured through the careful selection of optical power and glass types in the intermediate optics between the diffractive optical element and the objective. As an example, FIG. 10B depicts an example of the use of one or more optical elements 4010 (such as but not limited to different glass types) with refractive indices n1, n2, n3 and Abbe numbers v1, v2, v3 to compensate for the chromatic aberration. The different dispersion and optical powers of the one or more optical elements 4010 reduce or eradicate the chromatic aberration such that all colors can overlap at the foci.

Example multi-foci multiphoton imaging systems are provided herein that can be configured to perform reflection confocal microscopy. An added component can be used to allow for the system to perform reflection confocal microscopy. Reflection confocal microscopy works by detecting the reflected light from the sample. This may be done by picking off the reflected light coming back through the system. A multi-foci multiphoton imaging system with this modification may be used for reflection confocal microscopy or for detecting the surface of the sample.

In an example implementation according to the present disclosure, the example multi-foci multiphoton imaging system can be configured with a plurality of detector elements. For example, in the example multi-foci multiphoton imaging system 800 of FIG. 4B, the one or more detectors 880 can be a plurality of detector elements. Similarly to as described in connection with FIGS. 4A-4C, the light excitation path includes a foci generating element that generates a plurality of foci from an excitation beam and a scanning element that scans the foci across a sample, the foci generating element receiving light from the scanning element along the excitation pathway, as depicted in FIG. 4B. In this example implementation, the light collection path can include a plurality of detector elements that detect fluorescence emissions from the sample and a plurality of collection optical elements, where each collection optical element of the plurality of collection optical elements couples the emitted fluorescence light to each detector element of the plurality of detector elements. As a non-limiting example, the detection optics 910 can include optical lenses that focus the signal from the foci on to the detector elements. The detector elements may be a 1-D or 2-D array of individual detectors, such as but not limited to a multi-anode photomultiplier tube that receives the signal and provide an output to form the image. As a non-limiting example, the example multi-foci multiphoton imaging system can be configured such that each foci is mapped to a respective detector element.

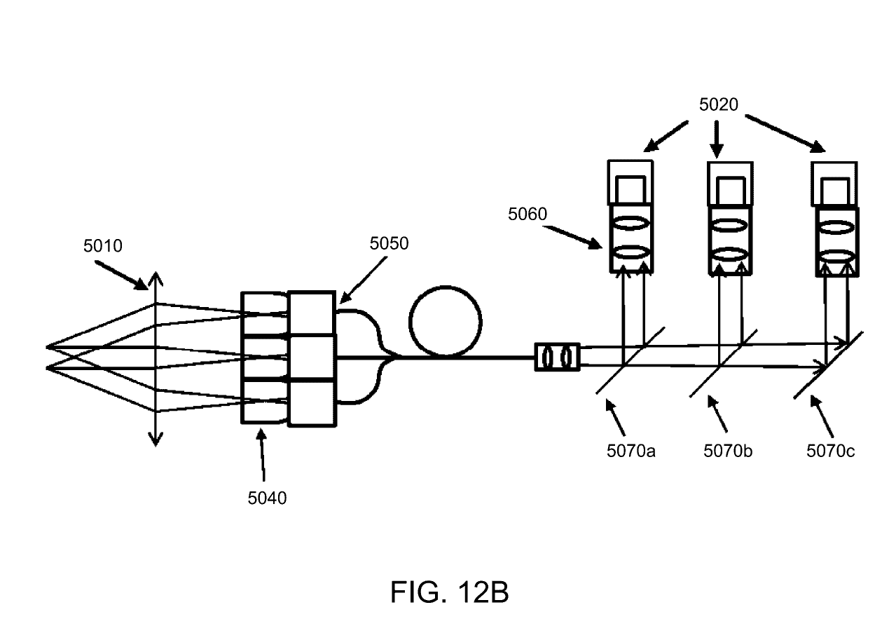

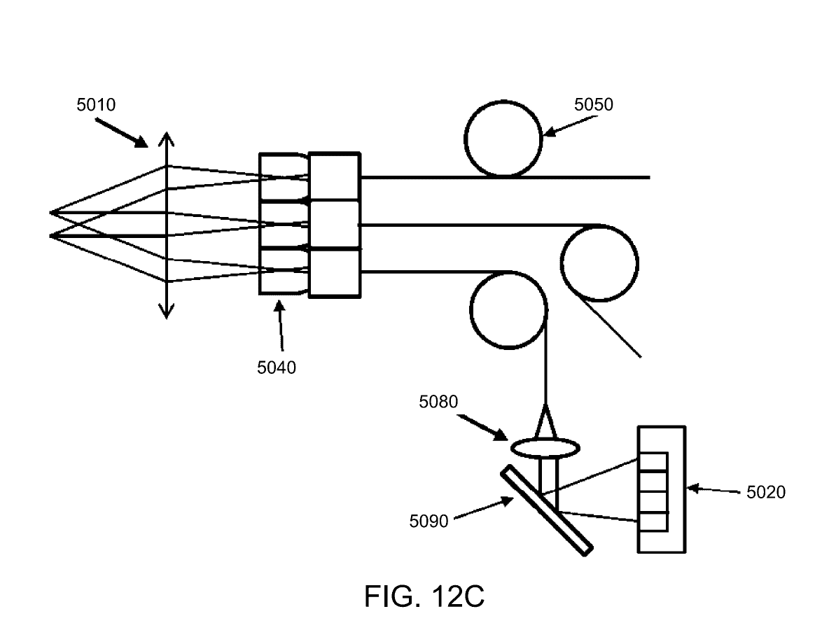

FIGS. 11A-12C depict various example configurations where an example multi-foci multiphoton imaging system includes a plurality of detector elements and a plurality of collection optical elements.

FIGS. 11A-11E show examples of various types of detection modes. In the example of FIG. 11A, the detection optics 5010 are configured to focus the signal on to the various detector elements 5020. The detection optics 5010 and the detector elements 5020 are configured and arranged such that each foci scans within the active area of the detector elements 5020. In cases where the scan range of each individual foci can exceed the active area of the detector (dotted lines), the sample may be scanned to account for the inactive regions of the detector elements 5020 or the detector elements 5020 may be shifted.

FIG. 11B shows another example configuration where the plurality of collection optical elements are in a lenslet array 5030 that is positioned at about one focal length before the detector elements 5020 and the detection optics 5010, so that the signal substantially does not move as the foci scans.

FIG. 11C shows another example configuration where the plurality of collection optical elements are a plurality of light collectors 5040 positioned behind the detection optics 5010 and in front of the detector elements 5020, such as shown. As shown in FIG. 11D, a light collector 5040 can be configured such that any light that enters the light collector 5040 (as shown in the illustrated light path) is redirected towards the exit aperture and therefore the active region of a respective detector element 5020, regardless of the input angle as long as it enters within a particular acceptance angle of the light collector 5040. For a given light collector 5040, this acceptance angle may be specified such that the light collector 5040 collects all the scattered signal photons and hence improve the signal to noise ratio of the example multi-foci multiphoton imaging system.

FIG. 11E shows an example of what may happen when the beam of fluorescence emitted light scans across the interface of the collection optics (illustrated as a lenslet array in this example). Signal can get scattered into the adjacent detectors and this can result in cross-talk between detectors and ghost images. In an example implementation, a combination of stage and beam scanning may be done such that the beam is not scanned across an interface and the sample is then shifted to accommodate the unscanned sample regions (i.e., the sample is shifted such that the foci can illuminate those unscanned sample regions). Alternatively, the ghost images may be accounted for and removed during the post-processing phase using various processing software.

FIGS. 12A-12C depict other example configurations where a multi-foci multiphoton imaging system includes a plurality of detector elements and a plurality of collection optical elements.

FIG. 12A shows an example multi-foci multiphoton imaging system where a light guide 5050 is positioned in the light collection path after the detection optics 5010 and after each of the light collectors 5040, to channel the signal with little loss to a respective detector element 5020 placed some distance away. As also shown in FIG. 12A, one or more collection optics 5060 may be positioned at the exit port of each respective light guide 5050. This example configuration allows for a modular approach to improvements or replacement of the detection system.

FIG. 12B shows an example multi-foci multiphoton imaging system where a light guide 5050 is positioned in the light collection path after the detection optics 5010 and after each of the light collectors 5040, to channel the signal with little loss to detector elements 5020 placed some distance away. One or more collection optics 5060 may be positioned at the exit port of each respective light guide 5050. As also shown in FIG. 12B, one or more dichroic filters (5070a, 5070b, and 5070c) may be positioned such that multiple channels may be used for the detection of different fluorophores.

FIG. 12C shows an example multi-foci multiphoton imaging system where a light guide 5050 is positioned in the light collection path after the detection optics 5010 and after each of the light collectors 5040, to channel the signal with little loss to detector elements 5020 placed some distance away. FIG. 12C shows an example spectral detection system that is possible with the use of light guides and light collectors. Signal is collected and channeled to the detector using light guide 5050. An optical component 5080 (that can be at least one of a collimating lens and a mirror) may be placed at the exit port of the light guide to collimate the signal beam and to direct the signal light on to a dispersive element 5090 (such as but not limited to a diffraction grating or a prism). This disperses the signal spectrally and the signal can be detected by a detector element, such as but not limited to a multi-anode PMT or a line CCD. As described in connection with the example of FIG. 12B, dichroic mirrors may be used to create spectral detection for each channel. In general, the non-descanned detection system is effective because of the shorter path lengths involved. Scattered light signals are collected more efficiently with larger collection optics and detectors. This is important for imaging of biological samples as they are typically highly scattering. It is also useful in detecting second-harmonic generated signals as SHG is primarily forward directed while the detected signals are mostly due to the back scattered SHG signal.

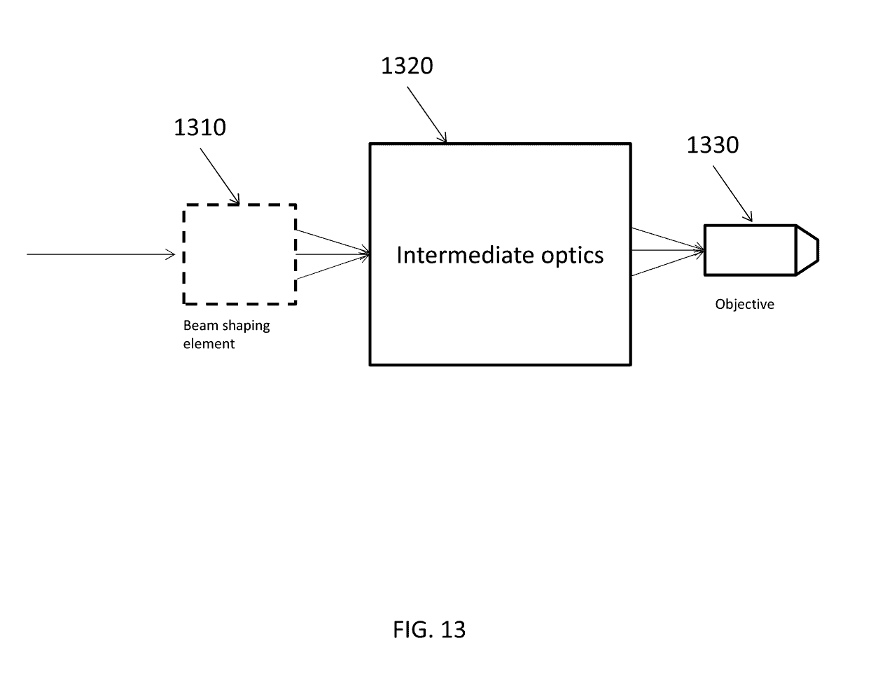

FIG. 13 schematically depicts an exemplary system to provide beamlets for illumination according to preferred embodiments of the present disclosure. The system can include a beam shaping element 1310, intermediate optics 1320, and an objective 1330. The beam shaping element 1310 can split the incident illumination beam into “beamlets.” The fan-out angle between the beamlets can be adjusted to meet the required angles at the objective and the beam size can be adjusted to match the dimensions of scanning mirrors that scan illumination light along the x- and/or y-axis.

The intermediate optics 1320 can image the beamlets to the objective 1330, where the beamlets can then be focused on the sample. In some embodiments, the intermediate optics can include one or more scanning or resonant mirrors. As a result of the various angles of incidence of the beamlets entering the objective, the beamlets can form an array of spots in the sample wherein neighboring spots in the array are separated by a pre-determined distance.

The array of spots can form a linear array, a two dimensional array or a three dimensional array using a 4×4 (N×N or N×M, with both N and M greater than 1) array, for example, can scan a region much faster than a 1×4 array. A three dimensional array (N×M×O), where N,M and O are all greater than 1) can further substantially increase the scan rate. This can be of particular importance in measuring dynamic events such as calcium waves, moving cells or membranes, or other moving objects.

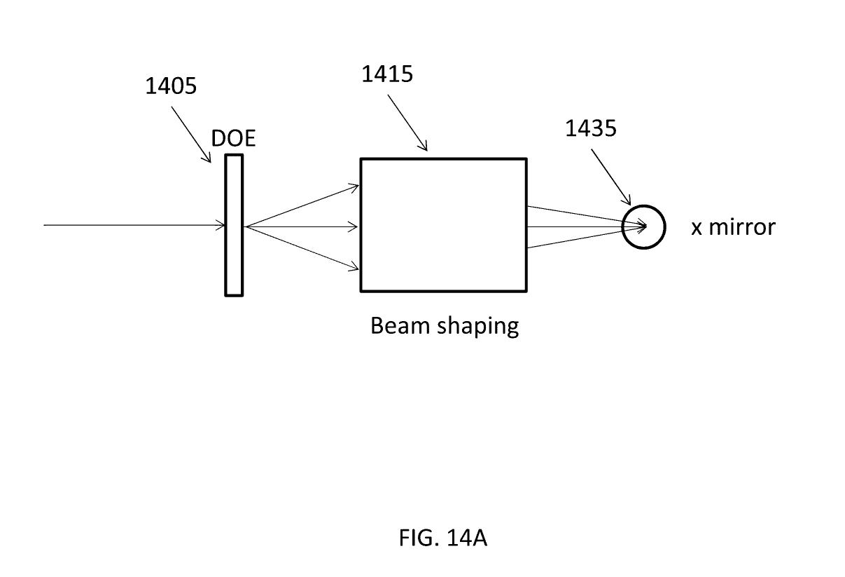

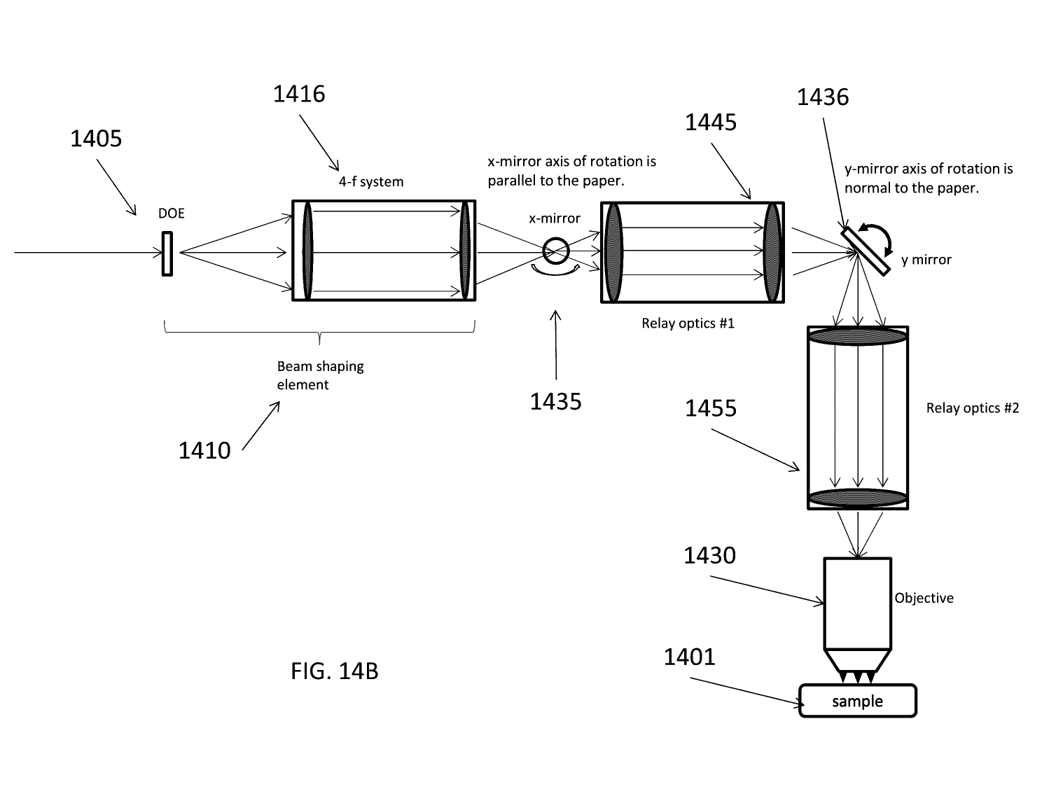

FIG. 14A schematically depicts an exemplary system including a diffractive optical element to provide beamlets for illumination according to some embodiments of the present disclosure. The system can include a diffractive optical element (DOE) 1405, beam shaping optics 1415, and one or more scanning mirrors 1435 to scan the beam along the x- and/or y-axis. The DOE 1405 can split the beam up into various beamlets. The beam shaping optics 1415 can be used to further shape the size of the beam to produce the desired fan-out angles and beam size for each of the beamlets.

FIG. 14B illustrates an exemplary system for producing beamlets for illumination including one or more 4f relay systems in accordance with some embodiments of the present disclosure. The system can include a beam shaping element 1410 comprising a DOE 1405 and a 4f system 1416, first relay optics 1445, second relay optics 1455, and an objective 1430.

The DOE 1405 can split the incident beam into beamlets. As depicted in FIG. 14B, the DOE 1405 can split the beam into three beamlets. Those skilled in the art will appreciate that the DOE 1405 can split the beam into any number of beamlets as necessary for specific applications. For example, the DOE 1405 can split the beam into 4, 9, or 16 beamlets in some embodiments. The 4-f system 1416 can be characterized by a magnification factor M. Depending on the magnification, the 4-f system 1416 can increase or decrease the size of the beam at the image plane that is conjugate to the DOE 1405. In some embodiments, the image plane conjugate to the DOE 1405 is located at the position of the scanning mirror 1435 that scans in the x-direction. The fan-out angle can similarly be increased or decreased depending upon the magnification factor. Selection of components in the 4-f system 1416 can help to maximize power throughput and can select the desired separation between foci at the sample 1401.

In some embodiments, the first relay optics 1445 can transmit the light from the x-axis scanning mirror 1435 to the y-axis scanning mirror 1436. It will be apparent to one skilled in the art that the x-axis scanning mirror 1435 and the y-axis scanning mirror 1436 can be interchanged in position. The second relay optics 1455 can then transmit the light from the y-axis scanning mirror 1436 to the objective 1430. The objective 1430 can focus the beamlets onto the sample 1401.

FIG. 15A depicts a portion of a system to split the illumination light into an even number of beamlets in accordance with various embodiments of the present disclosure. The system can include an array of mirrors 1510 and beamsplitters 1520 to divide the light into beamlets and direct the beamlets to a common scanning mirror 1535 that scans along the x-axis or y-axis. In some embodiments, the beamsplitters 1520 can be cube beamsplitters or plate beamsplitters and may be polarizing or non-polarizing. In some embodiments, the beamsplitters 1520 are 50:50 beamsplitters although any split ratio can be used including, but not limited to, 60:40, 75:25, and 90:10.

In the configuration depicted in FIG. 15A, the positions and angles of incidence of the beamlets on each of the mirrors 1510 can control the fan-out angle with respect to incidence on the scanning mirror 1535. In some embodiments, further beamshaping elements can be inserted into the path of one or more of the beamlets to control the beamlet size or angle with respect to the scanning mirror 1535. These optical elements can be separately controlled by individual motorized control elements such as MEMS actuators to adjust foci size (i.e. beam cross-sectional area), position and incidence angle.

The portion of the system schematically depicted in FIG. 15B is a modification of the portion of the system in FIG. 15A. The system shown in FIG. 15B can include mirrors 1510, beamsplitters 1520, the scanning mirror 1535, and an intensity adjuster 1525. In some embodiments, the intensity adjuster 1535 can be a polarizer or waveplate such as a quarter-waveplate or a half-waveplate. In a preferred embodiment of the system of FIG. 15B, the beamsplitters 1520 are polarizing beamsplitters. The optical power in each beamlet can be adjusted manually or automatically by adjusting the orientation of the intensity adjuster 1525. In some embodiments, the intensity adjuster 1525 can be used to equalize the optical power in each beamlet to overcome losses experienced in one or more of the beamlets (e.g., if one of the beamlets is further split or experiences greater absorption due to contact with more optical surfaces). Positioning of the mirrors 1510 can be used to achieve the desired fan-out angle with respect to the scanning mirror 1535. In some embodiments, further beamshaping elements can be inserted into the path of one or more of the beamlets to adjust beamlet size or angle with respect to the scanning mirror 1535.

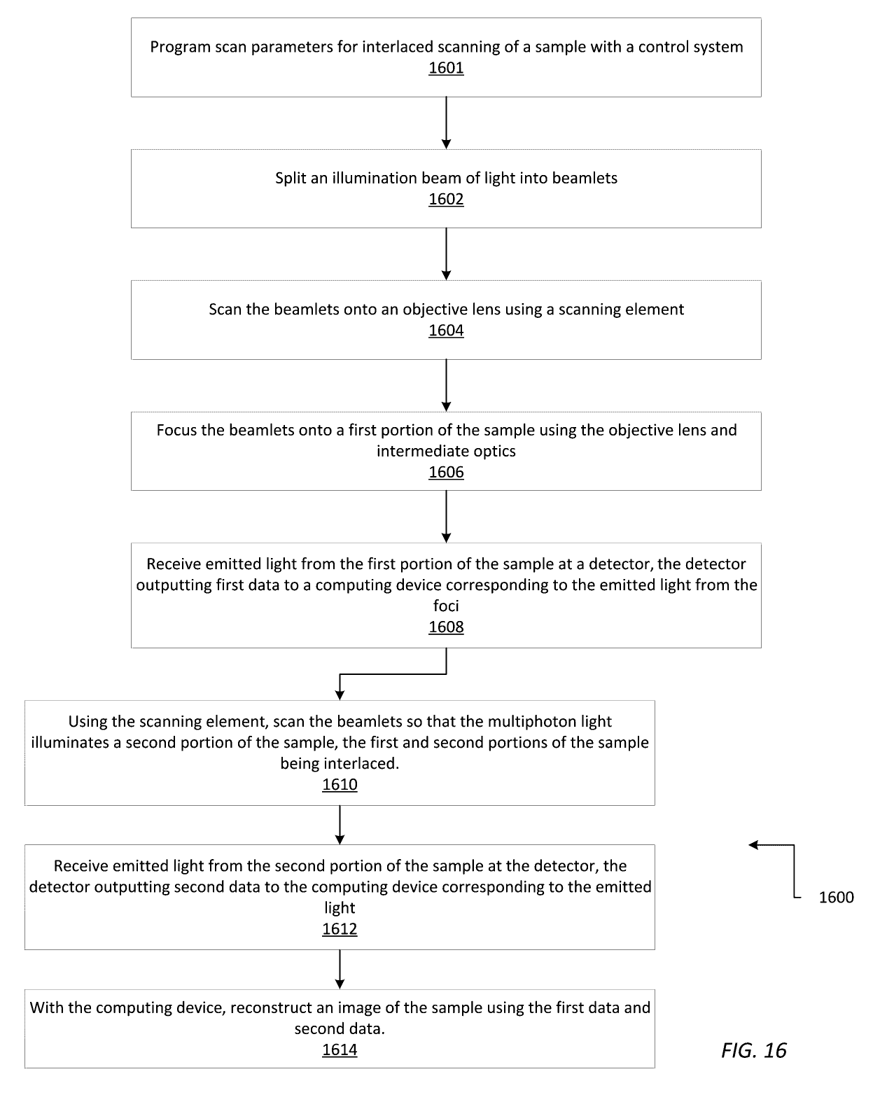

FIG. 16 depicts a process flow sequence 1600 for imaging a biological sample, 3D images of biological samples or whole organs in accordance with preferred embodiments of the invention. In the sequence, scan parameters are programmed with a control system for interlaced scanning of a sample (step 1601). In some embodiments, the control system can be similar to the control system 490 described above with reference to FIG. 4A. An illumination beam of light is split into beamlets (step 1602). For example, a DOE or an arrangement of beamsplitters and mirrors can be used to split the illumination beam of light as described previously. The beamlets are scanned onto an objective lens using a scanning element (step 1604). For example, the scanning element can be a scanning mirror that scans in the x-direction, y-direction, or both directions. Note that various scan patterns can be employed that overlap in two or three dimensions. A user can select from a plurality of present scan patterns stored in a memory, each having a preset or selectable scan parameter.

In the sequence 1600, the beamlets are focused onto a first portion of the sample using the objective lens and intermediate optics (step 1606). For example, the objective lens 1430 and the first and second relay systems 1445 and 1455 can be used to focus the beamlets onto the first portion of the sample 1401 with reference to FIG. 14B. The light emitted from the first portion of the sample is received at a detector, and the detector outputs first data to a computing device wherein the first data corresponds to the emitted light from the foci (step 1608). The scanning element scans the beamlets so that the multiphoton light illuminates a second portion of the sample (step 1610). The first and second portions of the sample are interlaced as described, for example, with relation to FIG. 7A.

The emitted light from the second portion of the sample is received at the detector, and the detector outputs second data to the computing device corresponding to the emitted light (step 1612). An image of the sample is reconstructed using the first data and the second data using the computing device (step 1614).

While the systems and methods of the present disclosure have been particularly shown and described with reference to the example embodiments and figures set forth herein, it will be understood by those skilled in the art that various changes in form and details may be made therein without departing from the spirit and scope thereof. Thus, the systems and methods of the present disclosure are not limited to the example embodiments and figures.

1. A multi-foci multiphoton imaging system comprising:
a light excitation path including a foci generating element that generates a plurality of foci from a multiphoton excitation beam and a scanning element that scans the foci across a sample; and
a light collection path that includes a detector device to detect fluorescence light emitted from the sample, wherein the light collection path includes a plurality of optical light guides that couple light from the scanned foci to the detector device, the optical light guides and the sample undergoing relative raster scanning movement.

2. The system of claim 1, wherein the detector device is a multi-anode photomultiplier tube (MA-PMT).

3. The system of claim 1, wherein the light guides are one or more optical fibers to couple the emitted light to the detector device.

4. The system of claim 1, wherein the light guides include one or more liquid light guides.

5. The system of claim 1, wherein each of the light guides is optically coupled to induce a fluorescence emission with a plurality of channels of a MA-PMT to detect a plurality of spectral channels.

6. The system of claim 1, wherein light guides are adapted to scan a plurality of adjacent regions to form an interlacing scan of the sample in response to control signals from a controller having a plurality of programmed scan parameters.

7. The system of claim 6, wherein the detector device includes a plurality of channels such that the interlacing scan of the sample reduces crosstalk between the detector device channels.

8. The system of claim 1, further comprising a multiphoton light source that emits at least two photons to illuminate each of the foci.

9. The system of claim 8, wherein the multiphoton light source comprises a pulsed laser.

10. The system of claim 1, wherein the light guides further comprises a plurality of at least 3 optical fibers in a linear array that couple light from the sample to the detector.

11. The system of claim 1, further comprising a tissue sectioning device connected to a controller.

12. The system of claim 1, further comprising a data processor that receives spectral data from the detector.

13. The system of claim 1, wherein the detector device comprises a detector system with a plurality of detector elements that detect a corresponding plurality of different wavelengths.

14. The system of claim 1, further comprising a feedback control system coupled to the scanning element, to detect at least one of: a position of the scanning element and an orientation of the scanning element.

15. The system of claim 1, further comprising an optical element disposed in the light excitation path to receive light from the foci generating element, the optical element introducing a chromatic dispersion that is opposite to that of the foci generating element.

16. The system of claim 1, wherein the light collection path further includes an objective lens and a lenslet array, the detector receiving fluorescence emissions from the lenslet array.

17. The system of claim 1, wherein the scanning element comprises a rotating mirror or a resonant mirror.

18. The system of claim 1, wherein each detector device has a collection area corresponding to a scattering distribution for each of a plurality of focal locations in the sample.

19. The system of claim 1, wherein the detector device detects a fluorescence signal from each foci in the sample.

20. The system of claim 1, wherein the detector device comprises an array of photomultiplier tubes.

21. The system of claim 1, wherein the excitation path further comprises a beam shaping device to form a plurality of beamlets that are scanned to a corresponding plurality of foci.

22. The system of claim 1, wherein the light collection path is a non-descanned collection path.

23. The system of claim 1, further comprising an optical beam shaping device to form a plurality of beamlets to be scanned to a one dimensional distribution, a two dimensional distribution or a three dimensional distribution of foci in the sample, the beam shaping device including a plurality of at least three mirrors that define an incidence angle of each beamlet on the sample, the mirrors being controlled to adjust size of each foci, position of each foci and incidence angle of each foci.

24. The system of claim 1, wherein each of one or more light guides is adapted to scan a plurality of adjacent regions to form an interlacing scan of the sample, the sample being positioned on a controlled translation stage movable along 3 independent orthogonal axis.

25. A method for multi-focal multiphoton imaging comprising:
using a scanning element to scan a plurality of foci across a region of interest of a sample, the plurality of foci being generated by at a foci generating element along a light excitation pathway, the scanning element operating in response to a control system to scan the foci across a scan pattern; and
detecting light from a plurality of focal locations in the region of interest to generate image data, the foci being coupled to a detector device with a plurality of light guides, the light guides and the sample undergoing relative movement.

26. The method of claim 25, further comprising using a fiber optic device including one or more fibers to couple emitted fluorescence light from an objective lens to the plurality of detector elements.

27. The method of claim 26, wherein each of the fibers is optically coupled with a respective detector element of the plurality of detector elements.

28. The method of claim 25, wherein each light guide of the plurality of light guides couples emitted fluorescence light from a respective collection optical element of a plurality of collection optical elements to a respective detector element of the plurality of detector elements.

29. The method of claim 25, further comprising using a tissue sectioning device to section a portion of the sample.

30. The method of claim 25, further comprising using a data processor to receive spectral data from the detector.

31. The method of claim 25, further comprising detecting using a detector array having a plurality of detector elements, each detector element having a collection area corresponding to a scattering distribution of fluorescence emission for each of a plurality of focal locations.

32. The method of claim 25, wherein the scanning element is a rotating mirror or a resonant mirror.

33. The method of claim 25, further comprising detecting using an array of photomultiplier elements.

34. The method of claim 25, wherein the foci generating element is a micro lens array, a diffractive optical element, or a plurality of optical fibers.

35. The method of claim 25, further comprising detecting different wavelengths of emitted light with a detector array having a first detector array and a second detector array.

36. The method of claim 35, further comprising coupling emitted light with a fiber optic device that transmits light along an optical path between the region of interest and the detector array.

37. The method of claim 25, further comprising coupling illuminating light with a fiber optic device from a light source to the scanning element.

38. The method of claim 25 further comprising actuating relative movement between the light emitted by the foci within the sample and the proximal ends of the light guides such that light from an array of at least 3 foci is coupled to a linear array of the light guides.

39. The method of claim 38 wherein the linear array comprises at least 4 optical fibers.

40. The method of claim 25 further comprising simultaneously illuminating each of a plurality of foci in the sample with at least two photons of light to induce a fluorescent light emission from each foci, the plurality of foci being generated with a diffractive optical element that generates at least three beamlets that are coupled to the sample with a 4-f lens system, a second scanning element, a second relay optical system and an objective lens.
